(19) United States
(12) Patent Application Publication
(10) Pub. No.: US 2021/0111432 A1
(43) Pub. Date: Apr. 15, 2021

(54) ELECTROLYTE ADDITIVES AND FORMULATIONS FOR ENERGY STORAGE DEVICES

(71) Applicant: Maxwell Technologies, Inc., San Diego, CA (US)

(72) Inventors: Mohammed-Yazid Saidi, La Mesa, CA (US); Matthew Petrowsky, San Diego, CA (US); Santhanam Raman, San Diego, CA (US); Xiaomei Xi, Carlsbad, CA (US)

(21) Appl. No.: 16/981,645

(22) PCT Filed: Mar. 21, 2019
(86) PCT No.: PCT/US2019/023361

§ 371 Date: Sep. 16, 2020

Related U.S. Application Data
(60) Provisional application No. 62/647,228, filed on Mar. 23, 2018.

(51) Int. Cl. H01M 10/0567; H01M 10/0525; H01M 10/0569; H01G 11/52; H01G 11/64; H01G 11/60

(52) U.S. Cl. CPC H01M 10/0567; H01M 10/0525; H01M 10/0569; H01G 11/06; H01G 11/64; H01G 11/60; H01M 2300/0042; H01G 11/52

(57) ABSTRACT

Electrolyte additives and formulations for energy storage devices are disclosed. The electrolyte additives include aromatic nitriles, combined carbonate and sulfur-containing additives, nitrogen-containing additives, or combinations thereof.

### INCORPORATION BY REFERENCE TO ANY PRIORITY APPLICATIONS

This application claims the benefit of U.S. Provisional Patent Application No. 62/647,228, filed Mar. 23, 2018, entitled “ELECTROLYTE ADDITIVES AND FORMULATIONS FOR ENERGY STORAGE DEVICES” the entirety of which is hereby incorporated by reference

### BACKGROUND

### Field of the Invention

The present invention relates generally to energy storage devices, and specifically to electrolyte additives for use in energy storage devices.

### Description of the Related Art

Electrical energy storage cells are widely used to provide power to electronic, electromechanical, electrochemical, and other useful devices. Such cells include primary chemical cells, secondary (rechargeable) cells, fuel cells, and various species of capacitors, including ultracapacitors. Increasing the operating voltage and temperature of energy storage devices, including capacitors, would be desirable for enhancing energy storage, increasing power capability, and broadening real-world use cases.

However, at higher operating temperatures and voltages energy storage devices may undergo undesired processes that result in a reduction in performance, or in outright cell failure. Such processes may include chemical and electrochemical reactions of the electrolyte and/or other components of the device. Specifically, under elevated temperatures an electrolyte may decompose to form acidic species such as hydrogen ions. Hydrogen ions may undergo reduction to produce hydrogen gas. Gas production is undesirable since a sealed cell will become pressurized, reducing cell efficiency and creating a potential hazard. Furthermore, the production of acidic byproducts can lead to corrosion of one or more components of a cell, for example, current collectors and cell casings.

Over the life of an energy storage device, deterioration of device performance may manifest as capacitance fade, increased equivalent series resistance (ESR) of the device, self-discharge, pseudocapacity, and/or gas formation. Thus, there is a need for electrolytes having improved stability under elevated voltage and temperature conditions of operation.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, an energy storage device can comprise an electrolyte including one or more additives provided herein. In some embodiments, the electrolyte additive can comprise an aromatic nitrile, combined carbonate and sulfur-containing additives, a nitrogen-containing additive, or combinations thereof. In some embodiments, the electrolyte additive can comprise an aromatic nitrile that is not benzonitrile.

In some embodiments, the carbonate and the sulfonate, such as the sultone, are present in the electrolyte in selected concentrations. In some embodiments, the carbonate is present in about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, or values therebetween. In further embodiments, the sulfonate, such as the sultone, is present in about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, or values therebetween. In further embodiments, the electrolyte solvent comprises a combination of ethylene carbonate (EC) and ethyl methyl carbonate (EMC), or a combination of EC, propylene carbonate (PC), diethyl carbonate (DEC), and dimethyl carbonate (DMC). In variations of these embodiments, the electrolyte solvent comprises EC in 10 to 30 vol % and EMC in 90 to 70 vol %, or EC, PC, DEC, and DMC in 10 to 30 vol % of each of EC, PC, DEC, and DMC.

In some embodiments the nitrogen-containing additive can be selected from an alkyl amine, a cyclic amine, and a nitrogen aromatic. In some embodiments, the nitrogen-containing additive can be hexamethylenetetramine.

In some embodiments, an aromatic nitrile can comprise a nitrogen-containing aromatic heterocycle, a benzene, or a combination thereof. In further embodiments, the nitrogen-containing aromatic heterocycle can comprise at least one nitrile. In still further embodiments, the benzene can comprise a plurality of nitriles.

One embodiment is an energy storage device that comprises a container comprising a cathode, an anode and a separator disposed between the cathode and the anode, an electrolyte, and a least one electrolyte additive selected from the group consisting of 1) an aromatic-nitrile additive, 2) a combined carbonate and sulfur-containing additive comprising a carbonate additive and a sulfur-containing additive, and 3) a nitrogen-containing additive selected from the group consisting of an alkyl amine, a cyclic amine, a nitrogen aromatic and combinations thereof.

In some embodiments, the electrolyte additive comprises the aromatic-nitrile additive. In some embodiments, the aromatic-nitrile additive is not benzonitrile. In some embodiments, the aromatic-nitrile additive comprises a compound of Formula (I):

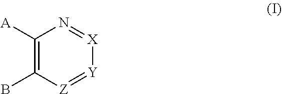

wherein each of A and B is independently H or CN, and each of X, Y and Z is independently N, C—H, or C—CN, wherein the compound of Formula (I) comprises at most 4 nitrile groups. In some embodiments, the aromatic-nitrile additive comprises a compound of Formula (II):

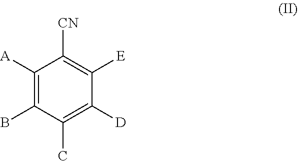

wherein each of A, B, C, D, and E is independently H or CN, wherein at least one of A, B, C, D, and E is H. In some embodiments, the aromatic-nitrile additive is selected from the group consisting of pyridine-2-carbonitrile, pyridine-3-carbonitrile, pyridine-4-carbonitrile, pyridine-2,4-dicarbonitrile, pyrimidine-2-carbonitrile, pyrimidine-4-carbonitrile, pyrazine-2-carbonitrile, pyrazine-2,3-dicarbonitrile, pyridazine-3-carbonitrile, phthalonitrile, isophthalonitrile, terephthalonitrile, 1,2,4,5 tetracyanobenzene and combinations thereof. In some embodiments, the electrolyte comprises about 0.05 wt % to about 10 wt % of the aromatic-nitrile additive.

In some embodiments, the electrolyte additive comprises the combined carbonate and sulfur-containing additive. In some embodiments, the carbonate additive is selected from the group consisting of ethylene carbonate, propylene carbonate, vinyl ethylene carbonate, vinylene carbonate, fluoroethylene carbonate, dimethyl carbonate, diethyl carbonate, ethyl methyl carbonate and combinations thereof. In some embodiments, the sulfur-containing additive comprises a sulfonate ester. In some embodiments, the sulfonate ester is a sultone. In some embodiments, the sulfonate ester is selected from the group consisting of 1,3-propane sultone, prop-1-ene-1,3-sultone and combinations thereof. In some embodiments, the electrolyte comprises about 0.1 wt % to about 10 wt % of the carbonate additive and about 0.1 wt % to about 10 wt % of the sulfonate ester.

In some embodiments, the electrolyte additive comprises the nitrogen-containing additive. In some embodiments, the alkyl amine is an aliphatic tertiary amine. In some embodiments, the cyclic amine is a hindered cyclic amine. In some embodiments, the nitrogen aromatic is not an amine. In some embodiments, the nitrogen-containing additive is selected from the group consisting of triethylamine, diisopropylethylamine, 2-methyl imidazole, quinuclidine, 1,4-diazabicyclo[2.2.2]octane, hexamethylenetetramine, N-methyl piperidine, N-methyl morpholine and combinations thereof. In some embodiments, the electrolyte comprises about 0.01 wt % to about 5 wt % of the nitrogen-containing additive.

In some embodiments, the energy storage device is a lithium ion battery. In some embodiments, the energy storage device is a lithium ion capacitor.

Another embodiment is an energy storage device that comprises a container comprising a cathode, an anode and a separator disposed between the cathode and the anode, and an electrolyte comprising a solvent and an electrolyte additive, wherein the solvent comprises ethylene carbonate/propylene carbonate/ethyl methyl carbonate/dimethyl carbonate (EC/PC/EMC/DMC), and the electrolyte additive comprises vinylene carbonate (VC).

In some embodiments, the electrolyte comprises about 0.75 wt % to about 1.25 wt % of the electrolyte additive. In some embodiments, the solvent comprises about 25 vol % of EC, about 5 vol % of PC, about 50 vol % of EMC and about 20 vol % of DMC.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 depicts an embodiment of an energy storage device.

FIGS. 2A and 2B depict aged ultracapacitor pouch cells having electrolytes including aromatic nitrile additives.

FIGS. 3A and 3B are graphs showing capacitance (FIG. 3A) and ESR (FIG. 3B) changes, respectively, of ultracapacitor pouch cells having electrolytes including an aromatic nitrile additive as provided herein, over time.

FIGS. 4A and 4B are graphs showing capacitance (FIG. 4A) and ESR (FIG. 4B) changes, respectively, of ultracapacitor pouch cells having electrolytes including an aromatic nitrile additive as provided herein, over time.

FIG. 5 depicts a chart providing capacitance fade versus number of operating cycles for various embodiments of energy storage devices including electrolytes comprising both a carbonate and a sultone.

FIG. 6 depicts a chart providing capacitance fade versus number of hours of operation at 2.7 V and 85° C. for various embodiments of energy storage devices including electrolytes having an N,N-diisopropylethylamine additive.

FIG. 7 depicts a chart providing equivalent series resistance (ESR) versus number of hours of operation at 2.7 V and 85° C. for various embodiments of energy storage devices including electrolytes having an N,N-diisopropylethylamine additive.

FIGS. 8A and 8B are graphs showing capacity retention at various discharge C-rates for lithium ion batteries with differing energy densities. FIG. 8A shows capacity retention rates for a relatively lower energy capacity battery, while FIG. 8B shows energy retention rates for a relatively higher energy capacity battery as described below.

FIG. 9 is a graph showing capacity retention at various discharge C-rates for lithium ion batteries.

FIG. 10 is a graph showing capacity retention over cycle life for lithium ion batteries.

### DETAILED DESCRIPTION

Various embodiments of electrolyte additives for use in energy storage devices are disclosed. Some embodiments include aromatic nitrile additives, nitrogen-containing additives, and combined carbonate and sulfur-containing additives. An energy storage device as provided herein may include one or more electrolyte additives as provided herein.

As provided herein, an energy storage device can be a capacitor, a lithium ion capacitor (LIC), an ultracapacitor, or a battery. The energy storage device can be characterized by an operating voltage. In some embodiments, an energy storage device described herein can have an operating voltage of about 2.2 V to about 3.8 V. In further embodiments, the operating voltage can be about 2.7 V to about 3 V, or values therebetween.

An energy storage device includes one or more electrodes. An electrode generally includes an electrode film and a current collector. The electrode film can be formed from a mixture of one or more binders and active electrode material. It will be understood that an electrolyte additive, and electrolyte including an additive provided herein, can be used in various embodiments with any of a number of energy storage devices and systems, such as one or more batteries, capacitors, capacitor-battery hybrids, fuel cells, or other energy storage systems or devices and combinations thereof. In some embodiments, an electrolyte additive or electrolyte including an additive described herein may be implemented in lithium ion capacitors, lithium ion batteries, or ultracapacitors.

An energy storage device as provided herein can be of any suitable configuration, for example planar, spirally wound, button shaped, or pouch. An energy storage device as provided herein can be a component of a system, for example, a power generation system, an uninterruptible power source systems (UPS), a photo voltaic power generation system, an energy recovery system for use in, for example, industrial machinery and/or transportation. An energy storage device as provided herein may be used to power various electronic device and/or motor vehicles, including hybrid electric vehicles (BEV), plug-in hybrid electric vehicles (PHEV), and/or electric vehicles (EV).

Without wishing to be limited by theory, certain embodiments of energy storage devices provided herein can incorporate features to neutralize acids produced during operation. Without wishing to be limited by theory, it is thought that chemical reactions of the electrolyte and/or other components of the device may produce acidic species.

Without wishing to be limited by theory, it is thought that, near positive electrodes, increased acidity is thought to arise due to the reactivity of electrolyte salts. When the electrolyte includes a fluoride-containing species such as tetrafluoroborate, corrosive acids such as hydrofluoric acid and tetrafluoroboric acid can be produced during operation. It is thought that the tetrafluoroborate anion is not stable in acidic solution, and may combine with a proton to form tetrafluoroboric acid, which may decompose into HF and BF₃. The acidity may arise due to oxidation of the anion of the electrolyte salt. It is thought that reducing acidity should reduce deleterious process, such as, for example, solvent polymerization and salt decomposition.

During device operation, a pH gradient may exist between a portion of the electrolyte near the positive electrode and a portion of the electrolyte near the negative electrode. Further, electrolyte degradation may form acidic species such as hydrogen ions, which may in turn undergo reduction to produce hydrogen gas and/or hydrocarbon gases. The consumption of protons renders the negative electrode alkaline (basic) as aging progresses.

Such degradation is thought to be accelerated at high temperatures. Furthermore, the production of acidic byproducts can lead to corrosion of one or more components of a cell, for example, current collectors and cell casings. Corrosion of the current collector can partially delaminate the metal from the activated carbon, thereby increasing the resistance of the device. Severe corrosion can cause complete delamination, rendering the device inoperable. Finally, electrolyte solvents can undergo reaction, for example, polymerization in the presence of acidic species, and such reaction products can undesirably coat an electrode surface, reducing electrode performance. In some embodiments, an electrolyte additive provided herein can act as an acid scavenger. In some embodiments, an electrolyte additive provided herein can reduce corrosion of cell components.

Limiting gas generation during operation of an energy storage device is an important operating parameter. Gas production is undesirable since a sealed cell will become pressurized, reducing cell efficiency and creating a potential hazard. Such devices generally have a housing, such as a metal container or can, which can withstand substantial internal pressure build-up due to gas formation. However, operation at high voltages or temperatures can generate so much gas that an overpressure condition is created. An overpressure condition may be mitigated for example, by opening a safety vent, which releases the built-up pressure. However, opening such a vent may render the device inoperable. Gas formation can also prevent a pouch or other non-rigid container configuration from being used, or can reduce the increased density of active material that would otherwise be provided by a pouch configuration, relative to a spiral bound or other device with a rigid container. Thus, mitigation of gas formation is desirable. In some embodiments, an electrolyte additive provided herein can reduce gas generation in an energy storage device.

The behavior of a particular electrolyte additive in a cell is difficult to predict. The conditions within an energy storage device under operation will induce complex chemical and electrochemical reactions and create species, including highly reactive species. Such species can be different between the bulk electrolyte and electrode surfaces. Thus, the effects on operating parameters, especially over the life of a device, are generally not predictable for any particular additive.

An energy storage device described herein may advantageously be characterized by reduced equivalent series resistance over the life of the device, which may provide a device with increased power density. In some embodiments, capacitors described herein may be characterized by reduced loss of capacity over the life of the device. Further improvements that may be realized in various embodiments include improved cycling performance, including improved capacitance stability during cycling, and reduced capacitance fade.

In some embodiments, an energy storage device, such as a capacitor, are configured to operate at 3 volts or greater. In further embodiments, an energy storage device, such as a capacitor, are configured to operate at 2.7 volts or greater. In some embodiments, secondary electrochemical reactions of the electrolyte and/or electrodes are reduced.

In some embodiments, an energy storage device, such as an ultracapacitor, is configured for operation at selected conditions of voltage and temperature. For example, an energy storage device can be configured for operation at 50° C., 55° C., 60° C., 65° C., 70° C., 75° C., 80° C., 85° C., 90° C., 95° C., 100° C., or greater temperatures. An energy storage device can be configured for continual operation at 2.7 V at 60 to 85° C., 2.8 V at 60 to 85° C., 2.9 V at 60 to 85° C., or 3 V at 60 to 85° C., or selected temperature values therebetween. In some embodiments, the conditions of voltage and temperature are about 2.7 V and about 85° C., about 2.8 V and about 80° C., about 2.9 V and about 75° C., about 3 V and about 70° C., or about 3.1 V and about 65° C.

In some embodiments, an energy storage device is configured for an operating voltage of about 2.7 to 3 volts at a temperature of at least about 65° C. for at least 500 k cycles.

An energy storage device may include one or more technologies described herein to enable the energy storage device to maintain a capacitance greater than about 80% of its initial capacitance, and/or less than 200% of its initial equivalent series resistance when operating at a voltage of about 2.7 to 3 volts over a period of about 1,500 hours, and/or at least 500 k cycles, and at a temperature of at least about 65° C. In other embodiments, the energy storage device is configured to maintain at least 75%, 85%, 90%, 95% or 99% of its initial capacitance when operating for a period of at least 1500 hours, and/or at least 500 k cycles at about 65° C. or greater.

In some embodiments, no significant gas formation occurs in an energy storage device following about 1500 hours of operation and/or at least 500 k cycles, where significance is determined by intervention of an adverse effect requiring operation under less than the rated conditions of the device.

Technologies described herein may be used separately or in combination in an energy storage device to enable operation under the selected conditions.

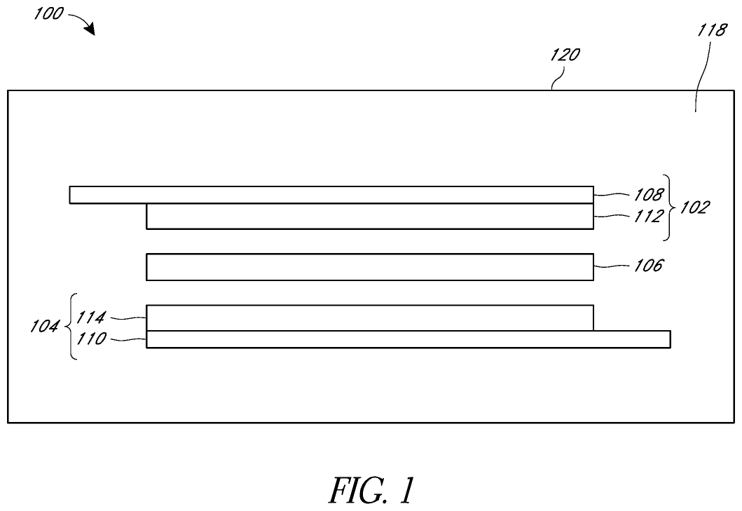

FIG. 1 shows a side cross-sectional schematic view of an example of an energy storage device 100. The energy storage device 100 may be classified as, for example, a capacitor, a battery, a capacitor-battery hybrid, a fuel cell or other energy storage device.

The device can have a first electrode 102, a second electrode 104, and a separator 106 positioned between the first electrode 102 and second electrode 104. The first electrode 102 and the second electrode 104 may be placed adjacent to respective opposing surfaces of the separator 106. The energy storage device 100 may include an electrolyte 118 to facilitate ionic transport between the electrodes 102, 104 of the energy storage device 100. For example, the electrolyte 118 may be in contact with the first electrode 102, the second electrode 104 and the separator 106. The electrolyte 118, the first electrode 102, the second electrode 104, and the separator 106 may be received within an energy storage device housing 120. One or more of the first electrode 102, the second electrode 104, and the separator 106, or constituent thereof, may comprise porous material. The pores within the porous material can provide containment for and/or increased surface area for reactivity with the electrolyte 118. The energy storage device housing 120 may be sealed around the first electrode 102, the second electrode 104 and the separator 106, and may be physically sealed from the surrounding environment.

In some embodiments, the first electrode 102 can be a “negative electrode” and the second electrode 104 can be the “positive electrode”. The separator 106 can be configured to electrically insulate two electrodes adjacent to opposing sides of the separator 106, such as the first electrode 102 and the second electrode 104, while permitting ionic transport between the two adjacent electrodes. The separator 106 can comprise a suitable porous, electrically insulating material. In some embodiments, the separator 106 can comprise a polymeric material. For example, the separator 106 can comprise a cellulosic material (e.g., paper), a polyethylene (PE) material, a polypropylene (PP) material, and/or a polyethylene and polypropylene material.

Generally, the first electrode 102 and second electrode 104 each comprise a current collector and an electrode film. Electrodes 102 and 104 comprise electrode films 112 and 114, respectively. The electrode films generally comprise one or more porous carbon based materials. In some embodiments, electrode films 112 and 114, can include mixtures comprising binder material and carbon material.

The carbon based materials may be selected from activated carbon, carbon black, conductive carbon, graphene-containing carbon, graphite, and combinations thereof. Activated carbon can be derived from a steam process or an acid/etching process. In some embodiments, both the first electrode 102 and the second electrode 104 comprise a current collector, one or more porous carbon based materials, and a fibrillated binder. Electrode films 112 and 114 can have any suitable shape, size and thickness. For example, the electrode films can have a thickness of about 30 microns (μm) to about 250 microns, for example, about 50 microns, about 100 microns, about 150 microns, about 200 microns, about 250 microns, or values therebetween.

The first electrode film 112 and the second electrode film 114 may also include binders. In some embodiments, the binder can include one or more fibrillizable binder components. The binder component may be fibrillized to provide a plurality of fibrils, the fibrils providing desired mechanical support for one or more other components of the film. It is thought that a matrix, lattice, or web of fibrils can be formed to provide mechanical structure to the electrode film. In some embodiments, a binder component can include one or more of a variety of suitable fibrillizable polymeric materials. The binder material can comprise a fluorinated binder, for example, polytetrafluoroethylene (PTFE), ultra-high molecular weight polyethylene (UHMWPE), polyvinylidene fluoride (PVDF), a PVDF co-polymer, poly(ethylene oxide) (PEO), or other suitable fibrillizable materials, used alone or in combination.

In some embodiments, one or more electrode films described herein can be fabricated using a dry fabrication process, for example, as described in U.S. Patent Publication No. 2005/0266298 and U.S. Patent Publication No. 2006/0146479, the entire contents of which are hereby incorporated herein by reference. As used herein, a dry fabrication process can refer to a process in which no or substantially no solvents are used in the formation of an electrode film. For example, components of the electrode film, including carbon materials and binders, may comprise dry particles. The dry particles for forming the electrode film may be combined to provide a dry particle electrode film mixture. In some embodiments, the electrode film may be formed from the dry particle electrode film mixture such that weight percentages of the components of the electrode film and weight percentages of the components of the dry particles electrode film mixture are substantially the same. In some embodiments, the electrode film formed from the dry particle electrode film mixture using the dry fabrication process may be free from, or substantially free from, any processing additives such as solvents and solvent residues resulting therefrom. In some embodiments, the resulting electrode films are free-standing electrode films formed using the dry process from the dry particle mixture. A process for forming an electrode film can include fibrillizing the fibrillizable binder component such that the electrode film comprises fibrillized binder.

As shown in FIG. 1, the first electrode 102 includes a first current collector 108 in contact with first electrode film 112, and the second electrode 104 includes a second current collector 110 in contact with the second electrode film 114, respectively. The first current collector 108 and the second current collector 110 may facilitate electrical coupling between each corresponding electrode film and an external electrical circuit (not shown). The first current collector 108 and/or the second current collector 110 can comprise one or more electrically conductive materials, and have any suitable shape and size selected to facilitate transfer of electrical charge between the corresponding electrode and an external circuit. For example, a current collector can include a metallic material, such as a material comprising aluminum, nickel, copper, rhenium, niobium, tantalum, and noble metals such as silver, gold, platinum, palladium, rhodium, osmium, iridium and alloys and combinations of the foregoing. For example, the first current collector 108 and/or the second current collector 110 can comprise an aluminum foil having a rectangular or substantially rectangular shape sized to provide transfer of electrical charge between the corresponding electrode and an external electrical circuit.

### Lithium Ion Energy Storage Devices

In some embodiments, energy storage device 100 can be a lithium ion capacitor (LIC) or a lithium ion battery (LIB). In some embodiments, the electrode film of a lithium ion energy storage device electrode can comprise one or more carbon materials, and a binder. Generally, one or more of the carbon materials are porous.

The cathode of a lithium ion capacitor can comprise carbonaceous materials for example activated carbon. The cathode of a lithium ion battery can comprise lithium metal oxides, for example, lithium cobalt oxides, lithium nickel manganese cobalt oxides, or lithium nickel iron manganese oxides, and optionally carbonaceous materials.

In some embodiments, the electrode film of a lithium ion energy storage device electrode comprises an electrode film mixture comprising carbon configured to reversibly intercalate lithium ions. In some embodiments, the lithium intercalating carbon is graphite, hard carbon and/or soft carbon. For example, the electrode film of the electrode can include a binder material, one or more of graphite, graphene-containing carbon, hard carbon and soft carbon, and an electrical conductivity promoting material. The electrical conductivity promoting material can be, for example, carbon black or other conductive carbon. In some embodiments, an electrode, such as an anode, is pre-doped with lithium ions.

In further embodiments, the energy storage device 100 is charged with a suitable lithium-containing electrolyte. For example, device 100 can include a lithium salt, and a solvent, such as a non-aqueous or organic solvent. Generally, the lithium salt includes an anion that is redox stable. In some embodiments, the anion can be monovalent. In some embodiments, a lithium salt can be selected from lithium hexafluorophosphate (LiPF₆), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), and combinations thereof. In some embodiments, an energy storage device provided herein can include a liquid solvent. A solvent as provided herein need not dissolve every component, and need not completely dissolve any component, of the electrolyte. In further embodiments, the solvent can be an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise LiPF₆, and one or more carbonates. In further embodiments, the electrolyte comprises an additive selected from vinylene carbonate (VC), vinyl ethylene carbonate (VEC), dimethylacetamide (DMAc), a hydro fluorinated ether branched cyclic carbonate, a hydro fluorinated ether (HFE), a hydro fluorinated ether ethylene carbonate (HFEEC), and a fluorinated ethylene carbonate (FEC). In further embodiments, the additive is present in about 0.5 wt %, about 1 wt %, about 2 wt %, about 3 wt %, about 4 wt %, about 5 wt %, or values therebetween, based on the total mass of electrolyte.

In some embodiments, the lithium ion capacitor includes one or more lithium ion intercalating components, as described in U.S. Patent Publication No. 2015/0287546, the entire contents of which are hereby incorporated herein by reference.

In some embodiments, the cathode does not include a metal oxide.

### Ultracapacitor

In some embodiments, energy storage device 100 can be an ultracapacitor configured to operate at about 2.7 V, 2.8 V, 2.9 V, 3 V, or greater than 3 V.

The energy storage device 100 can be charged with any suitable electrolyte. For example, device 100 can include a solvent and a salt including a cation and an anion. The cation can be a quaternary ammonium cation. In some embodiments, the quaternary ammonium cation can be selected from tetraalkylammoniums. In some embodiments, the tetraalkylammonium cation can be selected from cyclic ammoniums, for example, spiro-(1,1′)-bipyrrolidinium, and acyclic ammoniums, for example, triethylmethyl ammonium, triethylbenzylammonium, and tetraethyl ammonium. The quaternary ammonium salt can include an anion selected from the group consisting of hexafluorophosphate, tetrafluoroborate and iodide. The cation of the electrolyte salt can include a symmetrical, for example, cation spiro-(1,1′)-bipyrrolidinium. In some embodiments, the cation of the electrolyte salt can include an asymmetrical cation, for example, triethylmethyl ammonium. In some embodiments, the salt can include a spiro compound, for example a symmetrical or an unsymmetrical spiro compound. For example, the spiro compounds can be an N-spirobicyclic compound, including one or more 4-, 5-, 6-, or 7-membered rings. A symmetrical spiro cation can be spiro-(1,1′)-bipyrrolidinium tetrafluoroborate having the structure

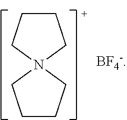

In some embodiments, the salt can include an asymmetrical spiro compound having unequally sized rings, or different substitution on equally sized rings. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 1 M. In certain embodiments, the salt concentration of the electrolyte can be about 0.2 M, about 0.3 M, about 0.4 M, about 0.5 M, about 0.6 M, about 0.7 M, about 0.8 M. about 0.9 M, about 1 M, about 1.1 M, about 1.2 M, or values therebetween.

In some embodiments, an energy storage device provided herein can include a liquid solvent. A solvent as provided herein need not dissolve every component, and need not completely dissolve any component, of the electrolyte. In further embodiments, the solvent can be an organic solvent. In some embodiments, a solvent can include one or more functional groups selected from nitriles, carbonates, ethers and/or esters. In some embodiments, the solvent can comprise a nitrile, for example, as acetonitrile. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise a quaternary ammonium salt, for example, tetrabutylammonium tetrafluoroborate (TBABF₄), and acetonitrile.

In a capacitor, the performance of the positive electrode may degrade more quickly than the negative electrode, due to clogging of the positive electrode pores with electrolyte decomposition product. Specifically, the acidic nature of the electrolyte is thought to initiate cationic polymerization of electrolyte solvents, for example acetonitrile, and the resulting oligomers and/or polymers are believed to clog the pores over the operating life of the capacitor, which results in a lowering of capacitance and increase in ESR of the cell.

In some embodiments, the ultracapacitor includes a positive electrode or a negative electrode comprising a treated carbon material, where the treated carbon material includes a reduction in a number of hydrogen-containing functional groups, nitrogen-containing functional groups and/or oxygen-containing functional groups, as described in U.S. Patent Publication No. 2014/0098464, the entire contents of which are hereby incorporated herein by reference. In further embodiments, the ultracapacitor includes an electrolyte comprising a quaternary ammonium salt with a concentration of less than one molar, as described in U.S. Patent Publication No. 2014/0104752, the entire contents of which are hereby incorporated herein by reference. In still further embodiments, the ultracapacitor includes a protective coating disposed on an inner housing surface, as described in U.S. Patent Publication No. 2014/0098463, the entire contents of which are hereby incorporated herein by reference. In yet further embodiments, the ultracapacitor includes a positive electrode or a negative electrode comprising a carbon-based layer having a selected porosity, for example, mesoporosity or microporosity, as described in U.S. Patent Publication No. 2014/0098465, the entire contents of which are hereby incorporated herein by reference. In some embodiments, the ultracapacitor includes electrolyte in an amount that is selected to correspond to the saturation quantity of components of the ultracapacitor as described in U.S. Patent Publication No. 2014/0368973, the entire contents of which are hereby incorporated herein by reference.

### Definitions

As used herein, the terms “battery” and “capacitor” are to be given their ordinary and customary meanings to a person of ordinary skill in the art. The terms “battery” and “capacitor” are nonexclusive of each other. A capacitor or battery can refer to a single electrochemical cell that may be operated alone, or operated as a component of a multi-cell system.

As used herein, the voltage of an energy storage device is the operating voltage for a single battery or capacitor cell. Voltage may exceed the rated voltage or be below the rated voltage under load, or according to manufacturing tolerances.

### Aromatic Nitrile Electrolyte Additives

An electrolyte additive, particularly useful for ultracapacitors, can be an aromatic nitrile. The aromatic nitriles generally comprise an aromatic moiety substituted by one or more nitrile moieties. The aromatic moiety can be selected from nitrogen-containing aromatic heterocycles, benzenes, and combinations thereof. The aromatic moiety can be bicyclic or tricyclic and can comprise fused rings, for example, quinoline or naphthalene, or adjacent rings, for example, biphenyl or 2-phenylpyridine.

Without wishing to be limited by theory, it is thought that an aromatic nitrile can undergo reduction at the cathode of an energy storage device to provide a reduced species, which may be negatively charged. It is believed that an aromatic nitrile can undergo a single electron reduction to provide a reduced species. The reduced species may be present as a radical anion or may undergo further reaction, for example, an additional reduction. The reduced species may include an unpaired electron. It is thought that such negatively charged species may diffuse into the electrolyte and neutralize acidic species in the electrolyte such as, for example, protons. The aromatic nitrile may be selected to form a reduced species having a degree of stability in the bulk electrolyte. Generally, the aromatic additive should have at least one electron withdrawing group to impart stability to the anion radical. By neutralizing acidic species, an aromatic nitrile can act as a corrosion inhibitor, and thus can provide a benefit described herein, for example, mitigating corrosion and/or gas formation.

An aromatic nitrile can comprise a nitrogen-containing aromatic heterocycle with at least one nitrile group bonded to the aromatic ring. In various embodiments, the nitrogen-containing aromatic heterocycle can be, for example, a pyridine, a pyrimidine, a pyrazine, or a pyridazine. Aromatic nitriles as provided herein include pyridinecarbonitriles, pyridinedicarbonitriles, for example, pyridine-2-carbonitrile, pyridine-3-carbonitrile, pyridine-4-carbonitrile, or pyridine-2,4-dicarbonitrile, pyrimidinecarbonitriles, for example, pyrimidine-2-carbonitrile, or pyrimidine-4-carbonitrile, pyrazinecarbonitriles, for example, pyrazine-2-carbonitrile or pyrazine-2,3-dicarbonitrile and, pyridazinecarbonitriles, for example, pyridazine-3-carbonitrile. In some embodiments, an aromatic nitrile can have the structure of Formula I. In Formula I, each of A and B is independently H or CN, and each of X, Y and Z is N, C—H, or C—CN, provided that at most three of X, Y and Z are N, and further provided that the compound includes at most 4 nitrile groups.

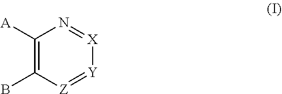

An aromatic nitrile can comprise a benzene with at least one nitrile group bonded to the benzene ring. Preferably, two or more nitriles are bonded to the benzene ring. This class includes phthalonitrile, isophthalonitrile, terephthalonitrile, and 1,2,4,5 tetracyanobenzene. In various embodiments, such aromatic nitriles can have the structure of Formula II. In some embodiments of Formula II, each of A, B, C, D, and E is independently H or CN, provided that at least one of A, B, C, D, and E is H. In further embodiments of Formula II, two of A, B, C, D and E are independently CN, and the rest are independently H. In some embodiments, the aromatic nitrile is not benzonitrile.

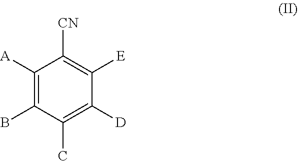

It is to be understood that, in Formula I and Formula II, each atom can be substituted by an isotope thereof.

In some embodiments, more than one aromatic nitrile can be present in the electrolyte. The total amount of aromatic nitrile additive can be present in the electrolyte in 10 wt % or less of the electrolyte. In some embodiments, the total amount of aromatic nitrile additive can be present in the electrolyte in about 10 wt %, about 8 wt %, about 6 wt %, about 5 wt %, about 4 wt %, about 3 wt %, about 2 wt %, about 1 wt %, about 0.5 wt %, about 0.2 wt %, about 0.1 wt %, or about 0.05 wt % of the total electrolyte, or values therebetween.

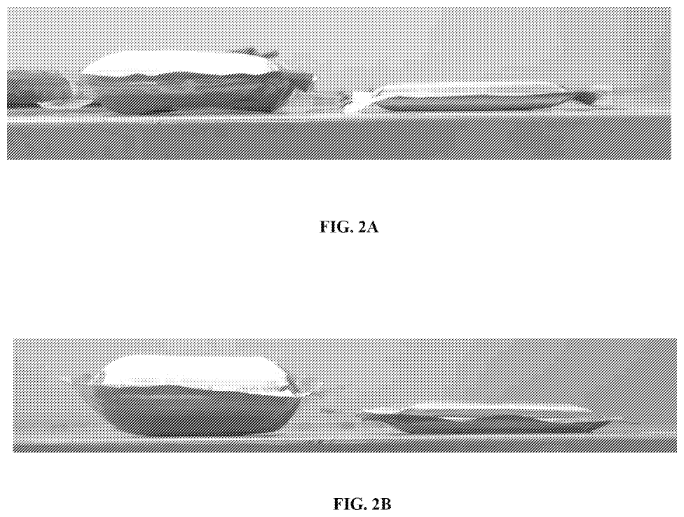

Incorporation of aromatic nitrile additives was found to reduce gassing of ultracapacitor pouch cells. As seen in FIG. 2A, aging of pouch cells at 2.5 V and 65 C for nine weeks resulted in a visible difference in cell gassing. In FIG. 2A, the cell on the left included a 1 M TEMABF₄-CH₃CN (1M triethylmethyl ammonium tetrafluoroborate in acetonitrile) electrolyte, while the cell on the right included a 1 M TEMABF₄-CH₃CN electrolyte having a 4-pyridinecarbonitrile (1.5 wt %) additive. FIG. 2B also shows two pouch cells aged at 2.5 V and 65 C for nine weeks. In FIG. 2B, the cell on the left included a 1 M TEMABF₄-CH₃CN electrolyte, while the cell on the right included a 1 M TEMABF₄-CH₃CN electrolyte having a 1,3-dicyanobenzene (6 wt %) additive. In each of FIGS. 2A and 2B, the cell on the left is distended due to gas production, while the cell on the right, including the aromatic nitrile additive, has undergone less gassing.

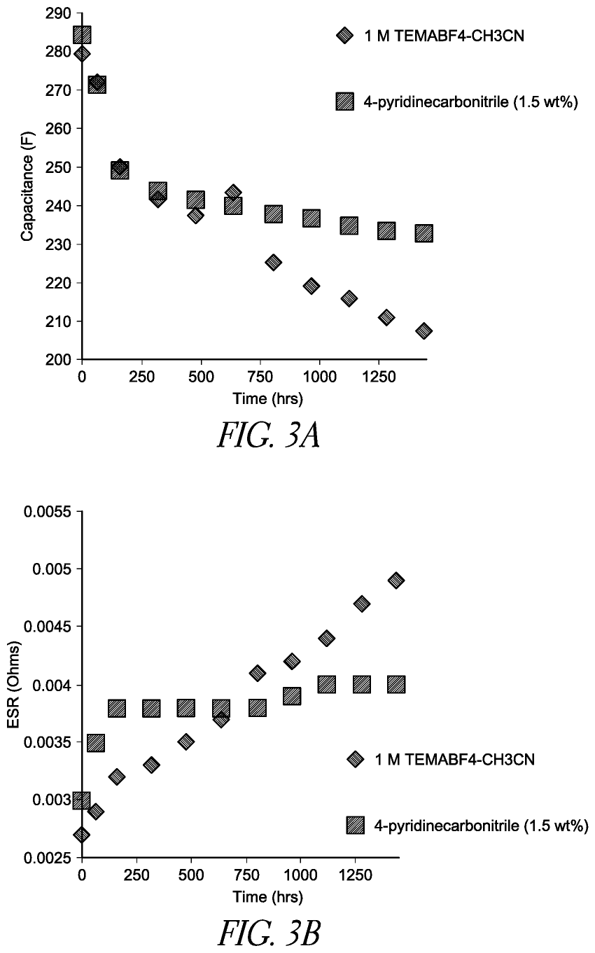

FIG. 3A shows a graph of capacitance versus aging time for ultracapacitor pouch cells held at 2.5 V and 65 C for nine weeks. In the graph, it can be seen that the cell including the aromatic nitrile additive (1 M TEMABF₄-CH₃CN and 1.5 wt % 4-pyridinecarbonitrile, indicated by squares) has retained more capacitance following the aging process compared to the cell not including the additive (1 M TEMABF₄-CH₃CN electrolyte, indicated by diamonds). The cell including the aromatic nitrile additive retained more than 75% of its initial capacitance following aging for nine weeks at 65° C.

FIG. 3B shows ESR versus aging time for pouch cells held at 2.5 V and 65 C for nine weeks. In the graph, it can be seen that the cell including the aromatic nitrile additive (1 M TEMABF₄-CH₃CN and 1.5 wt % 4-pyridinecarbonitrile, indicated by squares) has a smaller increase in ESR following the aging process compared to the cell not including the additive (1 M TEMABF₄-CH₃CN electrolyte, indicated by diamonds). The ESR of the cell including the aromatic nitrile additive increased by less than 50% following aging for nine weeks at 65° C.

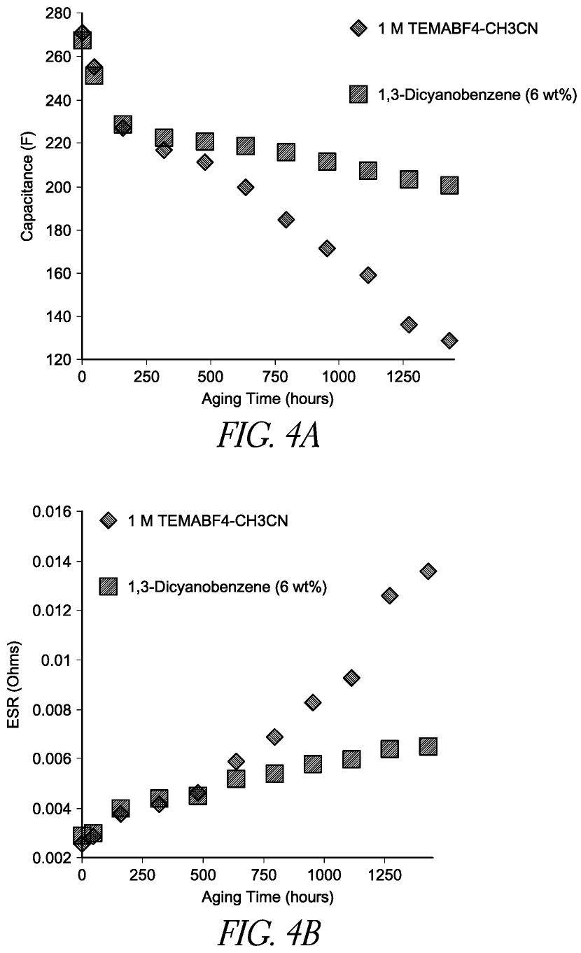

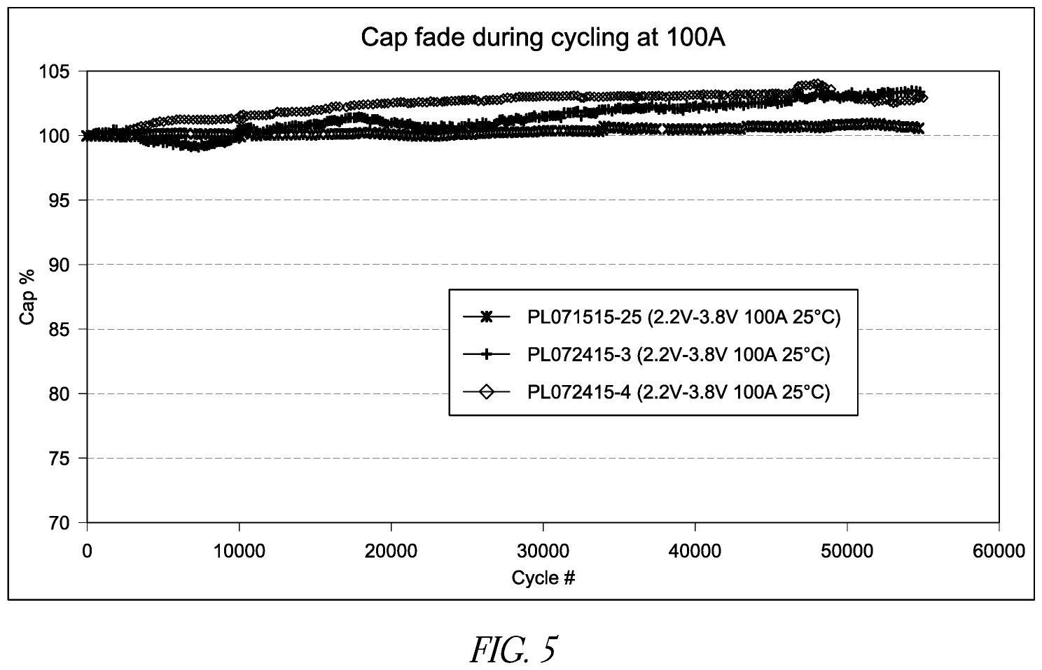

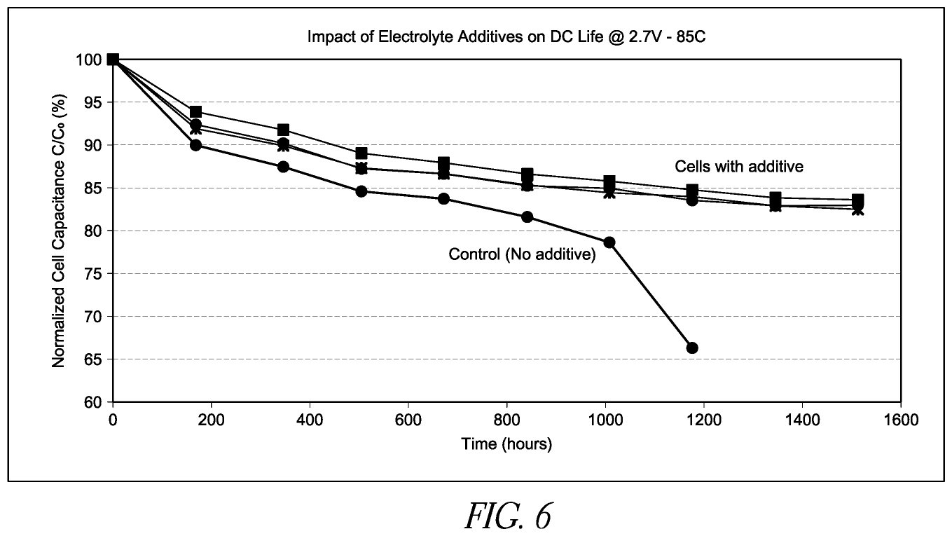

FIG. 4A shows a graph of capacitance versus aging time for ultracapacitor pouch cells held at 2.5 V and 65 C for nine weeks. In the graph, it can be seen that the cell including the aromatic nitrile additive (1 M TEMABF₄-CH₃CN and 6 wt % 1,3-dicyanobenzene additive, indicated by squares) has retained more capacitance following the aging process compared to the cell not including the additive (1 M TEMABF₄-CH₃CN electrolyte, indicated by diamonds). The cell including the aromatic nitrile additive retained more than 75% of its initial capacitance following aging for nine weeks at 65° C.

FIG. 4B shows ESR versus aging time for pouch cells held at 2.5 V and 65 C for nine weeks. In the graph, it can be seen that the cell including the aromatic nitrile additive (1 M TEMABF₄-CH₃CN and 6 wt % 1,3-dicyanobenzene, indicated by squares) has a smaller increase in ESR following the aging process compared to the cell not including the additive (1 M TEMABF₄-CH₃CN electrolyte, indicated by diamonds). The ESR of the cell including the aromatic nitrile additive increased by less than 300% following aging for nine weeks at 65° C.

Table 1 provides low temperature performance of ultracapacitor pouch cells at various temperatures.

TABLE 1
Low temperature capacitance and ESR of pouch cells with and without
additive (measured at the given temperature conditions).

| | | |
|---|---|---|
| | C (discharge) | ESR (discharge) |
| Electrolyte | (F) | (Ohms) |

Room Temperature

| | | |
|---|---|---|
| 1M TEMABF₄—CH₃CN | 266.3 | 0.0029 |
| 1M TEMABF₄—CH₃CN, 1,3- | 265.1 | 0.0030 |
| dicyanobenzene (6 wt %) | | |

−30° C. (equilibrated for 5 hours)

| | | |
|---|---|---|
| 1M TEMABF₄—CH₃CN | 267.7 | 0.0041 |
| 1M TEMABF₄—CH₃CN, 1,3- | 264.3 | 0.0041 |
| dicyanobenzene (6 wt %) | | |

### Combined Carbonate and Sulfur-Containing Additives

Without wishing to be limited by theory, it is thought that gas evolution in lithium ion energy storage devices, such as lithium ion batteries and lithium ion capacitors, can be caused by the reaction of lithiated carbon/graphite with the electrolyte components, as well as through decomposition of metastable components of the solid electrolyte interphase (SEI) at elevated temperatures. Additionally, gas may evolve from the reaction of the carbonates with Lewis acidic species, for example, PFS, which can result from decomposition of LiPF₆. Furthermore, oxygen may be produced at the cathode active materials at elevated temperature. It is thought that electrolyte additives, such as carbonates and oxidized-sulfur-containing additives, for example, sulfonate esters, can form stable SEI films on a carbon/graphite anode following reduction. Sulfonate esters, such as sultones, suppress swelling of cells at elevated temperature, however, it is believed that sulfonate esters, such as sultones, generally do not have the capability of forming a stable SEI. It has been found that the combination of both a carbonate and a sultone in an energy storage device electrolyte can provide a synergistic effect. In some embodiments, an energy storage device comprising an electrolyte including both a carbonate and a sultone additive can exhibit reduced gas evolution and improved cycle performance at elevated temperatures.

In some embodiments, an electrolyte for use in an energy storage device can include both a carbonate and a sulfonate ester, such as a sultone. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In still further embodiments, the sulfonate ester can be selected from 1,3-propane sultone (1,3-PS), and prop-1-ene-1,3-sultone (PES). In various embodiments, the energy storage device can be a capacitor, a lithium ion capacitor, or an ultracapacitor.

In some embodiments, a carbonate and a sulfonate ester such as a sultone are present in the electrolyte. In further embodiments, the carbonate is present in about 0.1 to 10 wt %, about 0.5 to 8 wt %, or about 1 to 5 wt %, and the sulfonate, such as the sultone, is present in about 0.1 to 10 wt %, about 0.5 to 8 wt %, or about 1 to 5 wt %. In further embodiments, the carbonate is present in about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, or values therebetween. In still further embodiments, the sulfonate, such as the sultone, is present in about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, or values therebetween.

In some embodiments, the electrolyte comprises about 0.8 to 1.4 M salt. In some embodiments, the salt can be LiPF₆. In still further embodiments, the electrolyte solvent comprises a combination of EC and EMC, or a combination of EC, PC, DEC, and DMC. In variations of these embodiments, the electrolyte solvent comprises EC in 10 to 30 vol % and EMC in 90 to 70 vol %, or EC, PC, DEC, and DMC in 10 to 30 vol % of each of EC, PC, DEC, and DMC. In certain embodiments, the total volume of additives cannot exceed 100%.

In some embodiments, no significant gas formation occurs in an energy storage device following about 3000 hours of operation, where significance is determined by intervention of an adverse effect leading to operation under less than the rated conditions of the device. In further embodiments, an energy storage device, such as a capacitor, including an electrolyte comprising both a carbonate and a sultone retains its initial capacitance following 50,000 charge-discharge cycles.

As seen in FIG. 5, capacitance fade is reduced for energy storage devices including electrolytes comprising both a carbonate and a sultone, compared to cells not including the additives.

### Nitrogen-Containing Additives

Without wishing to be limited by theory, it is thought that the effect of organic functional groups on the surface of a carbon-based electrode can be reduced by the presence of a nitrogen-containing additive, particularly for an ultracapacitor. For example, the acidic effect of functional groups such as carboxylic groups may be neutralized, which may be achieved by deprotonation of a proton bound by oxygen or carbon to form a carboxylate, alkoxide, phenolate, or enolate.

Further, it is thought that certain oxidatively stable amines can adsorb strongly on the electrode surface. In particular, it is thought that adsorption at the positive electrode of an energy storage device by an oxidatively stable amine can contribute to a passivation or solid electrolyte interphase (SEI) layer, reducing decomposition of the electrolyte at the positive electrode. Further, it is thought that certain nitrogen-containing additives provided herein are effective in deaggregating hydrofluoric acid to neutralize the electrolyte and limit corrosion. In some embodiments, an energy storage device including a nitrogen-containing additive as provided herein can be characterized by improved capacitance retention and ESR suppression over the life of the device.

In some embodiments, an electrolyte additive for use in an energy storage device includes a nitrogen-containing additive. In various embodiments, the energy storage device can be a battery, a capacitor, a lithium ion capacitor, or an ultracapacitor. In some embodiments, an energy storage device is provided, comprising a first electrode, a second electrode, and an electrolyte, wherein at least one of the positive electrode and the negative electrode is a dry electrode comprising a free-standing electrode film, and the electrolyte comprises a nitrogen-containing additive, wherein the nitrogen-containing additive can be selected from an alkyl amine, a cyclic amine, and a nitrogen aromatic.

In some embodiments, an energy storage device is provided, comprising a first electrode, a second electrode, and an electrolyte, wherein at least one of the positive electrode and the negative electrode is a dry electrode comprising a free-standing electrode film, and the electrolyte comprises a tertiary alkyl amine. In further embodiments, the tertiary alkyl amine can be an aliphatic tertiary amine. In still further embodiments, the aliphatic tertiary amine can include three lower alkyl groups, wherein the lower alkyl groups can independently be the same or different. In yet further embodiments, the lower alkyl groups can be selected from methyl, ethyl, propyl, isopropyl, butyl, sec-butyl, iso-butyl, and tert-butyl. In some embodiments, the aliphatic tertiary amine can be triethylamine, or diisopropylethylamine. In a preferred embodiment, the aliphatic tertiary amine is triethylamine.

In some embodiments, an energy storage device is provided, comprising a first electrode, a second electrode, and an electrolyte, wherein at least one of the positive electrode and the negative electrode is a dry electrode comprising a free-standing electrode film, and the electrolyte comprises a nitrogen aromatic selected from a pyridine, a pyrimidine, a pyrazine, a pyridazine, an imidazole, a pyrrole, a pyrazole, an indole, or a quinoline. In further embodiments, the nitrogen aromatic can be substituted by one or more lower alkyl groups. In further embodiments, the nitrogen aromatic does not include an amine. In still further embodiments, the nitrogen aromatic is monocyclic. In a preferred embodiment, the nitrogen aromatic is an imidazole, for example, 2-methyl imidazole.

FIG. 6 is a graph of capacitance versus floating time for 3000F cylindrical cells using 1M TEMABF₄-CH₃CN, where the “cells with additive” curves were for three cells containing 1 wt % disopropylethylamine electrolyte additive, and the control curve is an average of 4 cells using 1M TEMABF₄-CH₃CN electrolyte with no additive. As shown, capacitance fade was reduced in the capacitors including an N,N-diisopropylethylamine electrolyte additive following 1500 hours of operation at 2.7 V and 85° C., where the cells including the additive maintained at least 80% of their initial capacitance after 1500 hours.

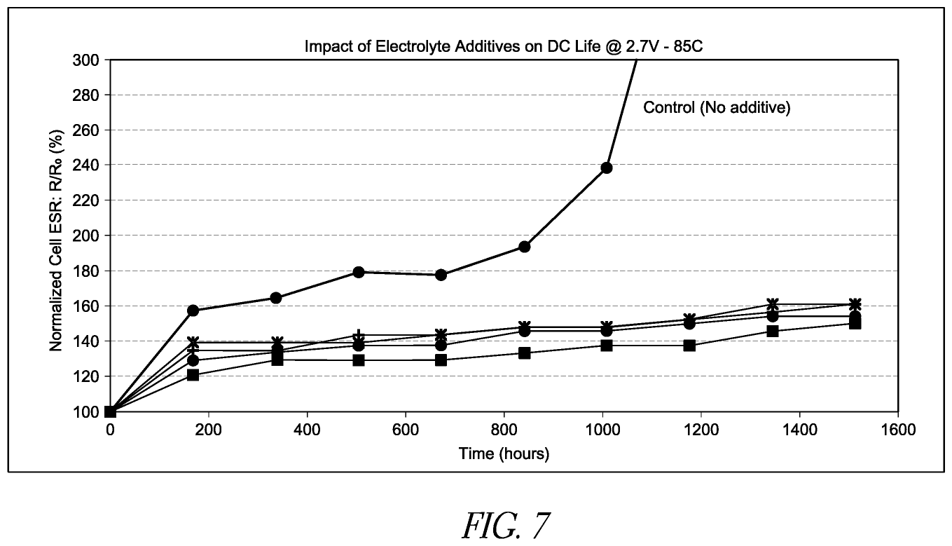

FIG. 7 is a graph of ESR versus floating time for 3000F cylindrical cells using 1M TEMABF₄-CH₃CN, where the “cells with additive” curves were for four cells (marked by square, circle, star, and +) containing 1 wt % disopropylethylamine electrolyte additive, and the control curve is an average of 4 cells using 1M TEMABF₄-CH₃CN electrolyte with no additive. As shown, ESR rise was reduced in the capacitors including an N,N-diisopropylethylamine electrolyte additive following 1500 hours of operation at 2.7 V and 85° C., where the cells including the additive had less than 180% of their initial ESR after 1500 hours.

In some embodiments, an energy storage device is provided, comprising a first electrode, a second electrode, and an electrolyte, wherein at least one of the positive electrode and the negative electrode is a dry electrode comprising a free-standing electrode film, and the electrolyte comprises a cyclic amine. In some embodiments, the cyclic amine can be a hindered amine. Without wishing to be limited by theory, it is thought that hindered cyclic amines may be more resistant to oxidative degradation. It is further believed that hindered cyclic amines may advantageously contribute to the formation of a passivation layer on electrode surfaces. Additionally, it is thought that oxidation-resistant amines may be more effective acid scavengers.

In further embodiments, an energy storage device is provided, comprising a first electrode, a second electrode, and an electrolyte, wherein at least one of the positive electrode and the negative electrode is a dry electrode comprising a free-standing electrode film, and the electrolyte comprises a polycyclic amine, for example, a bicyclic amine or a tricyclic amine. In some embodiments, the polycyclic amine can include a sterically hindered amine. In still further embodiments, the polycyclic amine is a bridged polycyclic amine. In yet further embodiments, the bridged polycyclic amine includes one or more nitrogen atoms at bridgehead positions. In some embodiments, the cyclic amine is selected from a quinuclidine, a 1,4-diazabicyclo[2.2.2]octane (DABCO), and a hexamethylenetetramine (methenamine). In a preferred embodiment, the polycyclic amine is hexamethylenetetramine.

It is thought that hexamethylenetetramine can adsorb strongly on the positive electrode surface, contributing to a passivation layer, and reduce decomposition of the electrolyte at the positive electrode, resulting in improved capacitance retention and ESR suppression. Further, it is thought that hexamethylenetetramine is effective in breaking up hydrofluoric acid aggregates in an electrolyte, to neutralize the electrolyte and limit corrosion, such as corrosion of metal current collectors. It is also thought that hexamethylenetetramine is an oxidatively stable amine, and thus undergoes less decomposition at the positive electrode compared to typical amines.

In some embodiments, an energy storage device is provided, comprising a first electrode, a second electrode, and an electrolyte, wherein at least one of the positive electrode and the negative electrode is a dry electrode comprising a free-standing electrode film, and the electrolyte comprises a monocyclic amine, such as an N-alkyl piperidine, for example N-methyl piperidine, or an N-alkyl morpholine, for example N-methyl morpholine.

In some embodiments, the nitrogen-containing additive is present in about 0.01 to 5%, about 0.05 to 2.5%, about 0.1 to 1%, or about 0.25 to 0.5% by total mass of the electrolyte. In further embodiments, the nitrogen-containing additive is present in about 0.1%, about 0.3%, about 0.5%, about 1%, about 1.5%, about 2%, about 2.5%, about 3%, about 3.5%, about 4%, about 4.5%, or about 5% by total mass of the electrolyte, or values therebetween. In further embodiments, hexamethylenetetramine is present in about 0.01 to 5%, about 0.05 to 2.5%, about 0.1 to 1%, or about 0.25 to 0.5% by total mass of the electrolyte. In further embodiments, hexamethylenetetramine is present in about 0.1%, about 0.3%, about 0.5%, about 1%, about 1.5%, about 2%, about 2.5%, about 3%, about 3.5%, about 4%, about 4.5%, or about 5% by total mass of the electrolyte, or values therebetween.

In some embodiments, the nitrogen-containing additive is miscible with the electrolyte solvent under operating conditions of the energy storage device.

In some embodiments, an energy storage device including an electrolyte comprising a nitrogen-containing additive as provided herein is configured to operate under selected conditions of voltage and/or temperature while maintaining less than 150% of its initial equivalent series resistance for over 1000 hours, and/or while maintaining greater than 85% of its initial capacitance for over 1000 hours. In further embodiments, an energy storage device including a nitrogen-containing electrolyte additive as provided herein can be characterized by less than 20% loss in capacity and/or less than 200% increase in ESR when operated at 65° C. and 2.7 V for at least 1500 hours. In still further embodiments, an energy storage device including a nitrogen-containing electrolyte additive as provided herein can be characterized by less than 35% rise in ESR after at least 1000 hours of operation at 70° C. and 3 V. In yet further embodiments, an energy storage device including a nitrogen-containing electrolyte additive as provided herein can be characterized by a less than 15% reduction in capacitance and/or less than 60% rise in ESR after at least 1200 hours of operation at 2.7 V and 85° C.

### Electrolyte for Lithium Ion Storage Devices

In some embodiments, electrolyte compositions for dry processed electrodes for use in energy storage devices are provided. In various embodiments, the energy storage device can be a lithium ion battery (LIB) or a lithium ion capacitor (LIC).

In some embodiments, a LIB including an electrolyte composition as provided herein may demonstrate higher discharge rate capability. Such higher discharge rate capability is desirable in high energy, high power applications such as electric vehicle propulsion. In conventional LIBs, discharge rates less than about C/5 are typically manageable by higher energy electrode designs, where C/5 is a discharge current relative to cell capacity such that the cell is drained in 5 hours. However, as the electrodes gained in thickness (as correlated with higher cell energy), electrolyte formulation becomes increasingly critical to address discharge performance at higher C-rates (1C and above). In some embodiments, the disclosed electrolyte formulations exhibit a discharge performance benefit, providing higher energy retention at higher discharge current.

In some embodiments, the lithium ion battery electrolyte comprises 1 to 1.3 M, preferably about 1.15 M lithium hexafluorophospate (LiPF₆), in a solvent comprising, consisting essentially, or consisting of ethylene carbonate/propylene carbonate/ethyl methyl carbonate/dimethyl carbonate (EC/PC/EMC/DMC), preferably at a composition of about 25 vol %/about 5 vol %/about 50 vol %/about 20 vol % respectively, with an additive comprising, consisting essentially, or consisting of vinylene carbonate (VC), wherein the additive is present in the electrolyte in about 0.75 wt % to about 1.25 wt %, or preferably about 1 wt %. In further embodiments, an electrolyte comprises, consists essentially, or consists of about 1.15 M lithium hexafluorophospate (LiPF₆), a solvent of (EC/PC/EMC/DMC), of about 25/5/50/20 vol % respectively, about 1 wt % vinylene carbonate (VC), and optionally, about 1 wt % lithium bis(oxalate)borate (LiBOB). Electrolyte compositions including the same carbonates in slightly altered volume percentages, and slightly altered salt concentration, may also meet the objectives described herein. In some embodiments, additional additives, electrolyte salts and carbonate materials may also be used to further improve the electrolyte formulation.

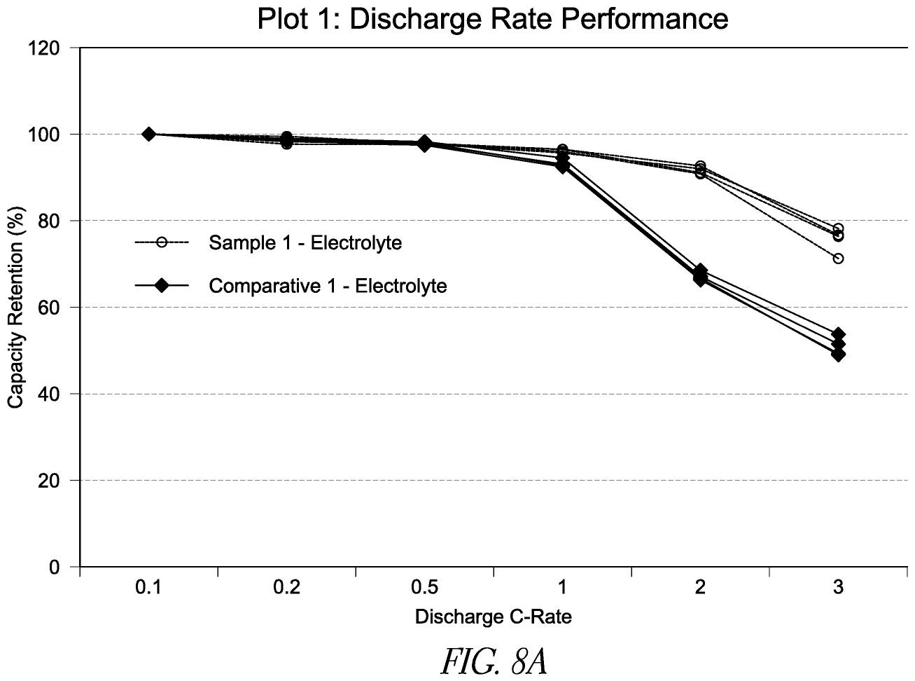

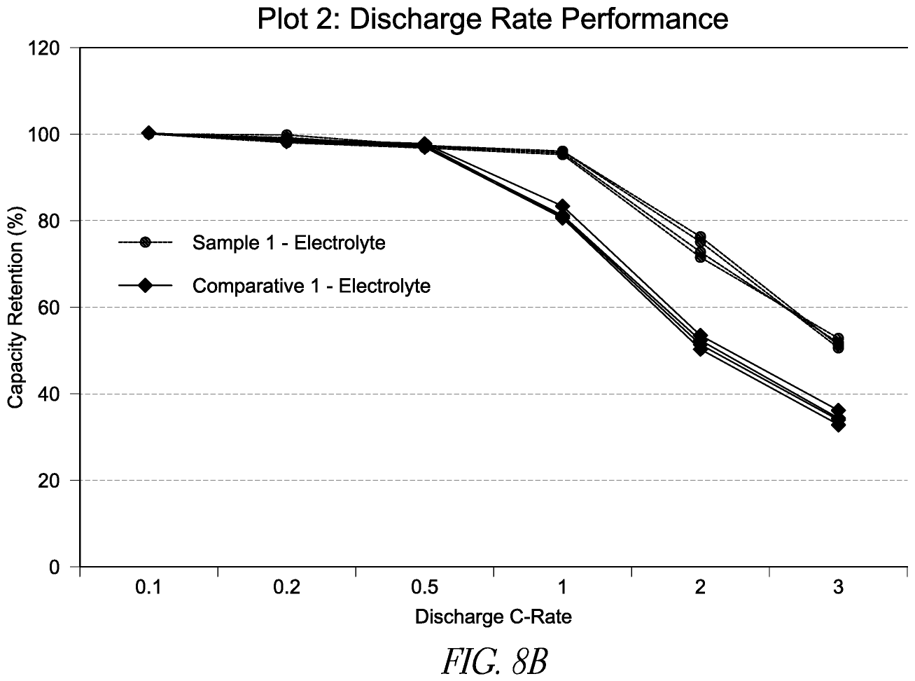

FIG. 8A provides a comparative discharge rate performance between an implementation of the above noted electrolyte formation, specifically 1.15 M lithium hexafluorophospate (LiPF₆), in a solvent of (EC/PC/EMC/DMC), 25/5/50/20 vol % respectively, with 1 wt % vinylene carbonate (VC) (Sample 1), against a conventional lithium ion electrolyte comprising 1.2 molar LiPF₆ in EC/PC/DEC in a volume ratio of 3/1/4 with 1 weight % VC (Comparative Sample 1). Both Sample 1 and Comparative Sample 1 included a lithium nickel manganese cobalt oxide (NMC) cathode (94 weight percent active and about 20 milligram per square centimeter coating weight) and a graphite anode (93 weight percent and about 12 milligram per square centimeter coating weight). As can be observed in FIG. 8A, the Sample 1 electrolyte provided higher energy retention than Comparative Sample 1 electrolyte at higher discharge rates (2C and 3C).

FIG. 8B depicts performance of batteries having higher energy dry electrode configurations (cathode: 94 weight % active at about 27 milligram per square centimeter coating weight; anode: 93 weight percent and about 14 milligram per square centimeter coating weight), and including the same set of electrolytes as provided for Sample 1 and Comparative Sample 1 with respect to FIG. 8A. As can be seen in FIG. 8B, the discharge rate performance advantage is maintained in batteries having the higher energy configuration. The Sample 1 batteries, in each electrode configuration, retained at least 70% of initial capacity at a discharge rate of 2 C, and at least 50% of initial capacity at a discharge rate of 3 C.

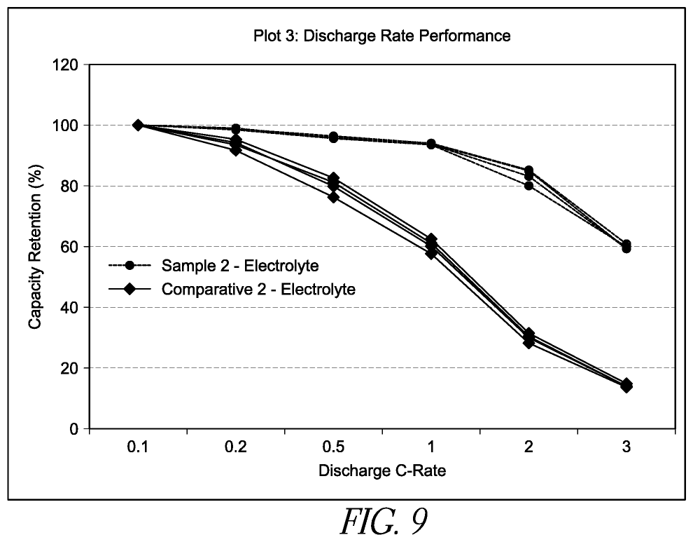

FIG. 9 compares performance of a battery including an electrolyte formulation of 1.15 M lithium hexafluorophospate (LiPF₆), in a solvent of (EC/PC/EMC/DMC), 25/5/50/20 vol % respectively, with 1 wt % vinylene carbonate (VC) and 1 wt % lithium bis(oxalate)borate (LiBOB) additives (Sample 2), against a battery including an electrolyte of 1 M LiPF₆ in EC/EMC (30/70 vol %) with 1 wt % LiBOB (Comparative Sample 2). The electrode pairs used in each of Sample 2 and Comparative Sample 2 are comprised of an nickel-manganese-cobalt (NMC) cathode (92 weight % active at about 27 milligram per square centimeter coating weight) and graphite anode (93 weight percent and about 15 milligram per square centimeter coating weight). Thus, the discharge rate performance of Sample 2 is improved over a conventional lithium ion battery electrolyte formulation (Comparative Sample 2). The Sample 2 battery retained at least 80% of initial capacity at a discharge rate of 2 C, and at least 60% of initial capacity at a discharge rate of 3 C.

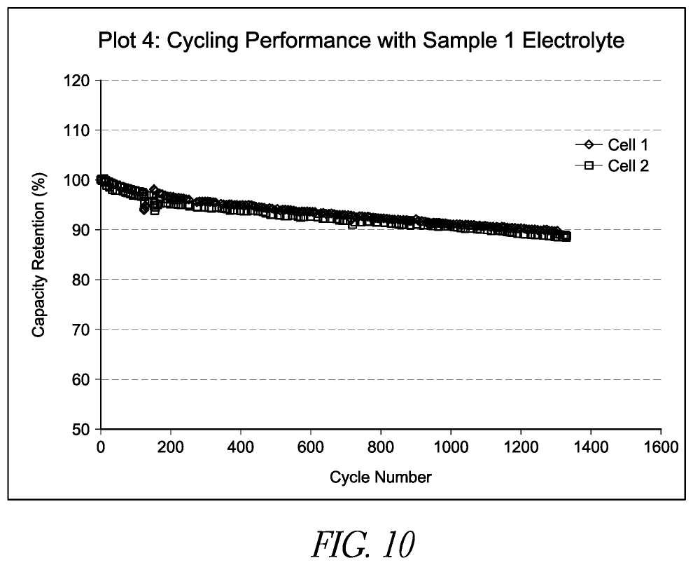

FIG. 10 provides cycle life results at a C/2 charge rate and 1 C discharge rate for a battery with an electrolyte according to Sample 1 in a cell having dry processed electrode pairs comprised of NMC cathodes (94 weight % active at about 27 milligram per square centimeter coating weight) and graphite anodes (96 weight percent and about 15 milligram per square centimeter coating weight). The cell capacity is well above 80% retention (a target commonly accepted as an end of life performance) at about 1300+ cycles. Thus, the LIB electrolyte formulation as provided herein may advantageously provide both higher discharge rate capability and competitive cycling performance.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. An energy storage device, comprising:
a container comprising a cathode, an anode and a separator disposed between the cathode and the anode;
an electrolyte; and
a least one electrolyte additive selected from the group consisting of 1) an aromatic-nitrile additive, 2) a combined carbonate and sulfur-containing additive comprising a carbonate additive and a sulfur-containing additive, and 3) a nitrogen-containing additive selected from the group consisting of an alkyl amine, a cyclic amine, a nitrogen aromatic and combinations thereof.

2. The device of claim 1, wherein the electrolyte additive comprises the aromatic-nitrile additive.

3. The device of claim 2, wherein the aromatic-nitrile additive is not benzonitrile.

4. The device of claim 2, wherein the aromatic-nitrile additive comprises a compound of Formula (I): 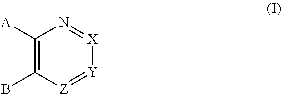
wherein:
each of A and B is independently H or CN; and
each of X, Y and Z is independently N, C—H, or C—CN, wherein the compound of Formula (I) comprises at most 4 nitrile groups.

5. The device of claim 2, wherein the aromatic-nitrile additive comprises a compound of Formula (II): 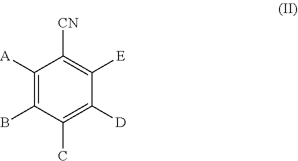
wherein:
each of A, B, C, D, and E is independently H or CN, wherein at least one of A, B, C, D, and E is H.

6. The device of claim 2, wherein the aromatic-nitrile additive is selected from the group consisting of pyridine-2-carbonitrile, pyridine-3-carbonitrile, pyridine-4-carbonitrile, pyridine-2,4-dicarbonitrile, pyrimidine-2-carbonitrile, pyrimidine-4-carbonitrile, pyrazine-2-carbonitrile, pyrazine-2,3-dicarbonitrile, pyridazine-3-carbonitrile, phthalonitrile, isophthalonitrile, terephthalonitrile, 1,2,4,5 tetracyanobenzene and combinations thereof.

7. The device of claim 2, wherein the electrolyte comprises about 0.05 wt % to about 10 wt % of the aromatic-nitrile additive.

8. The device of claim 1, wherein the electrolyte additive comprises the combined carbonate and sulfur-containing additive.

9. The device of claim 8, wherein the carbonate additive is selected from the group consisting of ethylene carbonate, propylene carbonate, vinyl ethylene carbonate, vinylene carbonate, fluoroethylene carbonate, dimethyl carbonate, diethyl carbonate, ethyl methyl carbonate and combinations thereof.

10. The device of claim 8, wherein the sulfur-containing additive comprises a sulfonate ester.

11. The device of claim 10, wherein the sulfonate ester is a sultone.

12. The device of claim 10, wherein the sulfonate ester is selected from the group consisting of 1,3-propane sultone, prop-1-ene-1,3-sultone and combinations thereof.

13. The device of claim 10, wherein the electrolyte comprises about 0.1 wt % to about 10 wt % of the carbonate additive and about 0.1 wt % to about 10 wt % of the sulfonate ester.

14. The device of claim 1, wherein the electrolyte additive comprises the nitrogen-containing additive.

15. The device of claim 14, wherein the alkyl amine is an aliphatic tertiary amine.

16. The device of claim 14, wherein the cyclic amine is a hindered cyclic amine.

17. The device of claim 14, wherein the nitrogen aromatic is not an amine.

18. The device of claim 14, wherein the nitrogen-containing additive is selected from the group consisting of triethylamine, diisopropylethylamine, 2-methyl imidazole, quinuclidine, 1,4-diazabicyclo[2.2.2]octane, hexamethylenetetramine, N-methyl piperidine, N-methyl morpholine and combinations thereof.

19. The device of claim 14, wherein the electrolyte comprises about 0.01 wt % to about 5 wt % of the nitrogen-containing additive.

20. The device of claim 1, wherein the energy storage device is a lithium ion battery.

21. The device of claim 1, wherein the energy storage device is a lithium ion capacitor.

22. An energy storage device, comprising:
a container comprising a cathode, an anode and a separator disposed between the cathode and the anode; and
an electrolyte comprising a solvent and an electrolyte additive, wherein the solvent comprises ethylene carbonate/propylene carbonate/ethyl methyl carbonate/dimethyl carbonate (EC/PC/EMC/DMC), and the electrolyte additive comprises vinylene carbonate (VC).

23. The device of claim 22, wherein the electrolyte comprises about 0.75 wt % to about 1.25 wt % of the electrolyte additive.

24. The device of claim 22, wherein the solvent comprises about 25 vol % of EC, about 5 vol % of PC, about 50 vol % of EMC and about 20 vol % of DMC.
